(19) United States
(12) Patent Application Publication
(10) Pub. No.: US 2008/0093550 A1
(43) Pub. Date: Apr. 24, 2008

(54) Method For Adhering Nanostructures to End of Probe of Microscope and Microscope Having Probe Made By the Same Method

(75) Inventors: Seung-Hun Hong, Seoul (KR); Dai-Sik Kim, Seoul (KR); Sung Myung, Daejeon (KR); Na-Rae Cho, Seoul (KR); Jin-Eun Kim, Gyeonggi-do (KR)

Correspondence Address: VENABLE LLP, P.O. BOX 34385, WASHINGTON, DC, 20043-9998, US

(73) Assignee: Seoul National University Industry Foundation, Seoul (KR)

(21) Appl. No.: 11/667,551

(22) PCT Filed: Nov. 11, 2005
(86) PCT No.: PCT/KR05/03832

§ 371 Date: May 11, 2007

(30) Foreign Application Priority Data
Nov. 12, 2004 (KR) 10-2004-0092598
Nov. 9, 2005 (KR) 10-2005-0106979

(51) Int. Cl. G21K 5/04; B05D 1/32

(52) U.S. Cl. 250/310; 427/282

(57) ABSTRACT

There is provided a method for selectively adsorbing nano-structures on the end of the probe of a scanning probe microscope. The method includes the steps of: forming the adsorbing prevention coating layer on the probe surface of the scanning probe microscope; removing the adsorbing prevention coating layer formed on the end of the probe; and adsorbing nano-structures on the end of the probe at which the adsorbing prevention coating layer is removed, in the solution or the gas containing nano-structures.

### TECHNICAL FIELD

The present invention relates to a method for selectively adsorbing nano-structures to the end of a probe of a scanning probe microscope.

### BACKGROUND ART

Recently, it is possible that a measurement with nanometer resolution in the material world is realized due to the rapid development of a scanning probe microscope. The major part to determine the resolution of the scanning probe microscope is the end portion of the probe, currently the most widely used probe is made of materials such as Si₃N₄, Si or the like and the radius of the end portion of the probe reaches below 10 nm. However, it is very difficult to control the shape or the property of the probe end portion which is the major part according to the user's demand by current technology.

On the other hand, due to the rapid development of recent nano-technology, nano-particles with the uniform shape made of various materials have been developed. For example, there are various nano-particles or various nano-wires made of Au, Ag, CdSe or the like and optical properties, electrical properties, shapes, sizes thereof can be very exactly controlled. And, such development of nano-technology allows further precise scanning probe microscope to be developed.

An effort to develop the new type of scanning probe microscope with attaching nano-particles or nano-structures to the probe of scanning probe microscope has been previously progressed. As one example, as shown in FIG. 2, Banin et al., after CdSe fluorescent nano-particles are adsorbed on the overall probe surface, has realized a nano-fluorescent resonance energy transfer (nano-FRET) imaging using the same (see U. Banin et al., JACS 108, 93 (2004)). However, since a measurement in this case is implemented between atoms on a detection sample surface and the plurality of nano-particles adsorbed on the probe surface, there is a problem that the resolution drastically decreases.

However, if the nano-particles are adsorbed to only the end portion of the probe, since the measurement is performed between atoms on the detection sample surface and nano-particles adsorbed to the end portion of the probe, the accurate measurement can be possible in comparison with conventional scanning probe microscope; and, therefore, it can be drastically improved in the resolution of scanning probe microscope through this.

Further, the new type of scanning probe microscope can be developed using such probe. For example, in case when nano-particles are attached to the end portion of the probe, it is possible to develop the nano-optical measurement type such as nano-FRET, nano-surface-enhanced Raman scattering (nano-SERS) or the like. And also, the probe attaching thereto nano-particles of the uniform shape allows the nano-scale force to be measured more precisely in comparison with conventional methods.

### DISCLOSURE

Technical Problem

It is, therefore, the objective of the present invention, to provide scanning probe microscope capable of performing the more accurate measurement by providing the method for selectively adsorbing nano-particles or nano-structures only on the end portion of the probe of scanning probe microscope, thereby obtaining more improved resolution.

Technical Solution

In accordance with one aspect of the present invention, there is provided the method for selectively adsorbing nano-structures on the end portion of the probe of scaning probe microscope, the method comprising the steps of: forming the adsorbing prevention coating layer on the probe surface of a scanning probe microscope; removing the adsorbing prevention coating layer formed on the end portion of the probe; and adsorbing the nano-structures on the end portion of the probe from which the adsorbing prevention coating layer is removed, in the solution or the gas containing nano-structures.

In accordance with another aspect of the present invention, there is provided the method for selectively adsorbing nano-structures on the end portion of the probe of a scanning probe microscope, after the step of removing the adsorbing prevention coating layer, further comprising the steps of: adsorbing one end of linker molecules on the end portion of the probe from which the adsorbing prevention coating layer is removed; and adsorbing the nano-structure on the other end of linker molecules in the solution or the gas containing the nano-structure.

In accordance with still another aspect of the present invention, there is provided the method for selectively adsorbing nano-structures on the end portion of a probe of scanning probe microscope, wherein the step of forming the adsorbing prevention coating layer is characterized in that, after performing the step of forming at least one intermediate layer on the probe surface, the adsorbing prevention coating layer is formed on the intermediate layer; and the step of removing the adsorbing prevention coating layer is characterized in that at least the portion of the intermediate layer and the adsorbing prevention coating layer formed on the end portion of the probe is removed.

In accordance with still another aspect of the present invention, there is provided a scanning probe microscope installed thereon a probe, the scanning probe microscope comprising: an adsorption prevention coating layer formed on a probe surface except the end portion of the probe; and the probe provided with a nano-structure selectively adsorbed on the end portion of the probe.

In accordance with still another aspect of the present invention, there is provided a scanning probe microscope installed thereon a probe, further comprising: a linker molecule provided with a terminal group adsorbed on the end portion of the probe and the other terminal group adsorbed on the nano-structure.

In accordance with still another aspect of the present invention, there is provided a scanning probe microscope installed thereon a probe, wherein at least one intermediate layer is formed between the probe surface and the adsorption prevention coating layer.

Advantageous Effects

In accordance with the embodiment of the present invention, nano-structure is adsorbed directly or through the medium of the link molecule on the end portion of the probe on which the adsorption prevention coating layer is not formed. The scanning probe microscope mounting thereon such probe supplies more improved resolution in comparison with conventional a scanning probe microscope, thereby allowing nano-control to be performed more precisely.

### DESCRIPTION OF DRAWINGS

The above and other objectives and features of the present invention will become apparent from the following description of the preferred embodiments given in conjunction with the accompanying drawings, in which:

FIG. 1 is the schematic diagram illustrating the application example of the probe of scanning probe microscope attached thereto nano-particles;

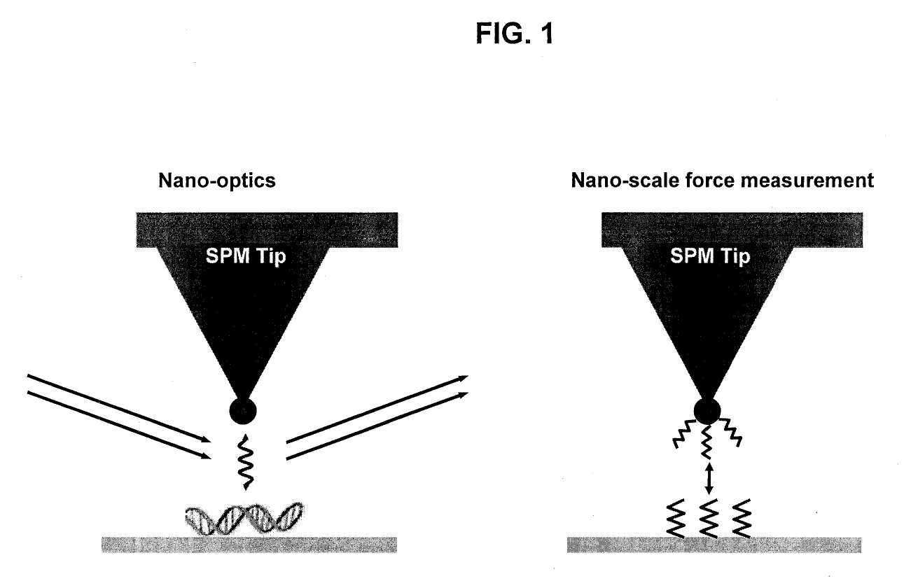

FIG. 2 is the partial enlarged photograph of the conventional nano-particle probe and the schematic diagram showing the experimental example using the same;

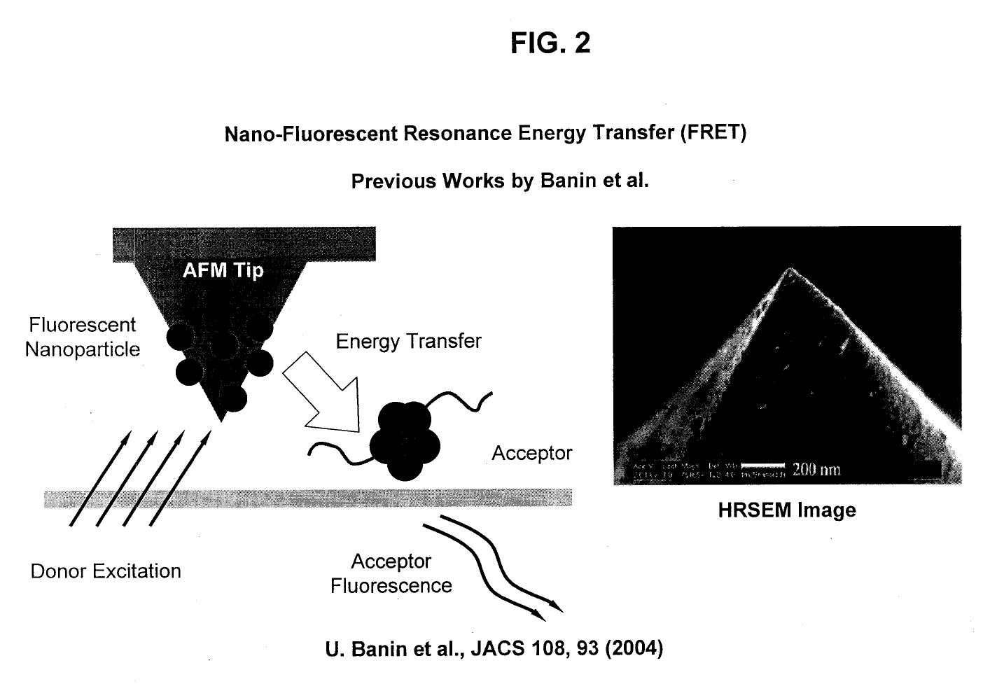

FIG. 3 is the schematic diagram representing the method for directly adsorbing a nano-structure on the end portion of the probe;

FIG. 4 is the schematic diagram illustrating the method for adsorbing a nano-structure to the end portion of the probe using linker molecules;

FIG. 5 is the schematic diagram of the embodiment of the present invention for adsorbing an Au nano-particle on the end portion of the probe having a SiO₂ surface;

FIG. 6 is the scanning electron microscope (SEM) image photograph showing that a 50 nm Au nano-particle is selectively adsorbed on the end portion of the probe; and

FIG. 7 is the schematic diagram depicting the method for removing the adsorption prevention coating layer at the end portion of the probe by polishing.

### BEST MODE FOR THE INVENTION

Other objectives and aspects of the invention will become apparent from the following description of the embodiments with reference to the accompanying drawings, which is set forth hereinafter.

In the present invention, nano-structures mean that it generally represents nano-sized structures such as nano-particles, nano-tubes, nano-wires, carbon nano-tubes, self-assembled monolayers (SAMs), deoxyribonucleic acids (DNAs), ribonucleic acids (RNAs), proteins, antigens, antibodies and cells or the like.

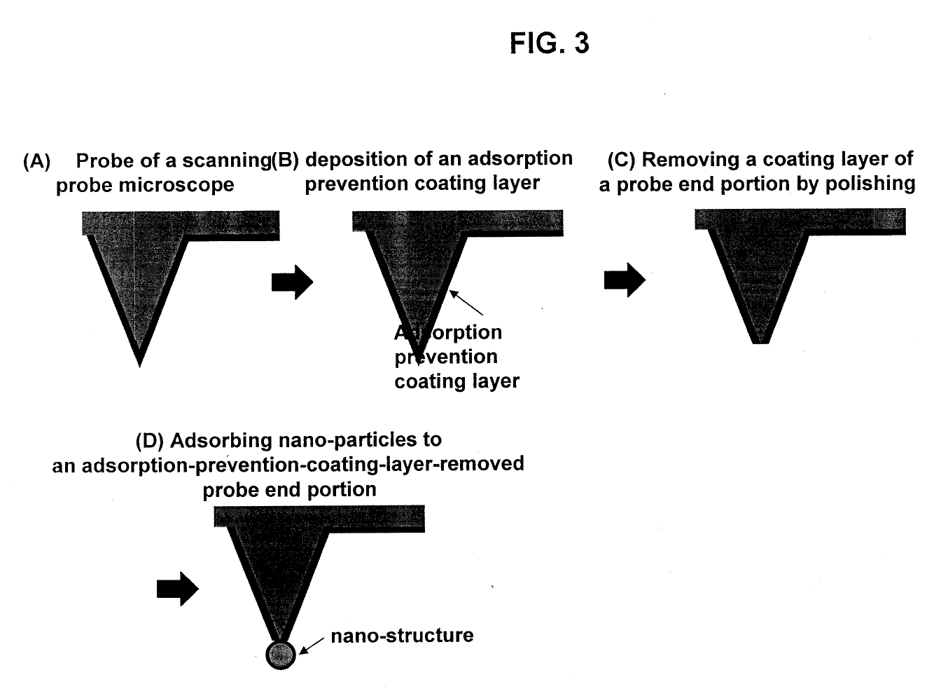

The basic concept of the selective adsorption in accordance with the embodiment of the present invention is described with reference to FIG. 3. At first, the adsorption prevention coating layer to prevent the nano-structure from being adsorbed thereon is formed on a surface of a probe ((A) of FIG. 3) ((B) of FIG. 3). And then, a coating layer formed on the end portion of the probe is removed by polishing the end portion of the probe ((C) of FIG. 3). Herein, the polishing method can be performed by chemical mechanical polishing (CMP) or it can be performed by the method of scanning the predetermined solid surface several times with a constant force by installing a plurality of probes on scanning probe microscope.

The probe surface is exposed only at the end portion of the probe by polishing and the remaining portion is surface-treated with the adsorption prevention coating layer. Herein, if the exposed probe surface represents the positive (+) charge and the nano-structure represents the negative (−) charge, the nano-structure can be directly adsorbed on only the end portion of the probe. And, if the exposed probe surface represents the negative (−) charge such as SiO₂, Au or the like and nano-structures represent the positive (+) charge, the nano-structure can be directly adsorbed on only the end portion of the probe ((D) of FIG. 3).

However, if the exposed probe surface represents the negative (−) charge and the nano-structure also represents the negative (−) charge, there occurs the repulsive force due to the same polarity, therefore, it is difficult that the nano-structure is directly adsorbed on the end portion of the probe.

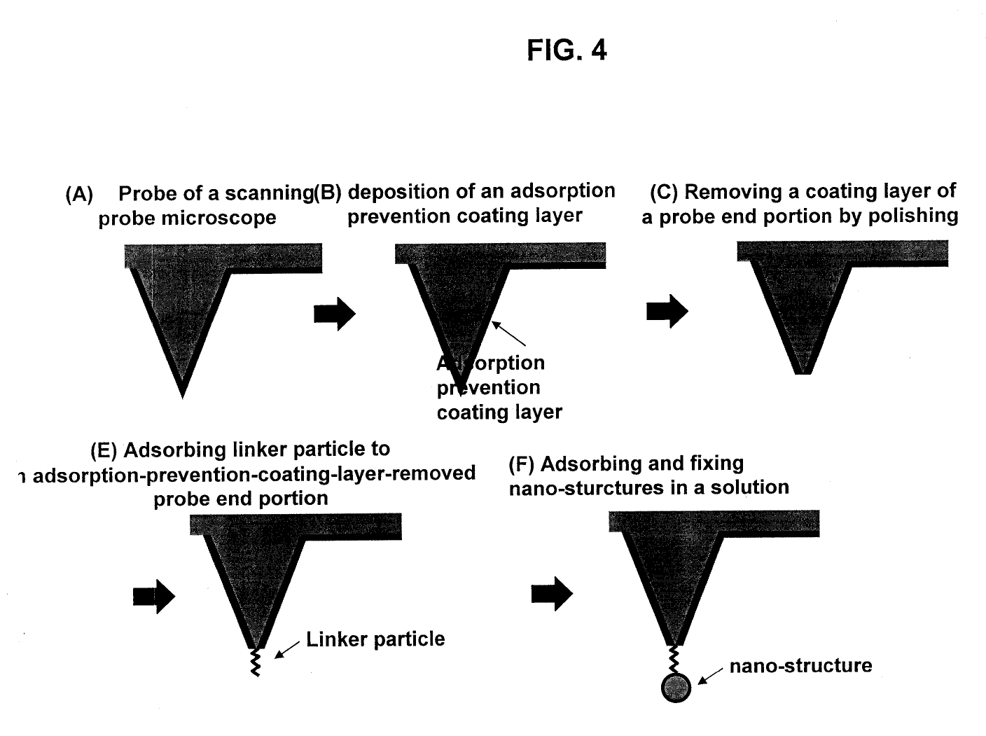

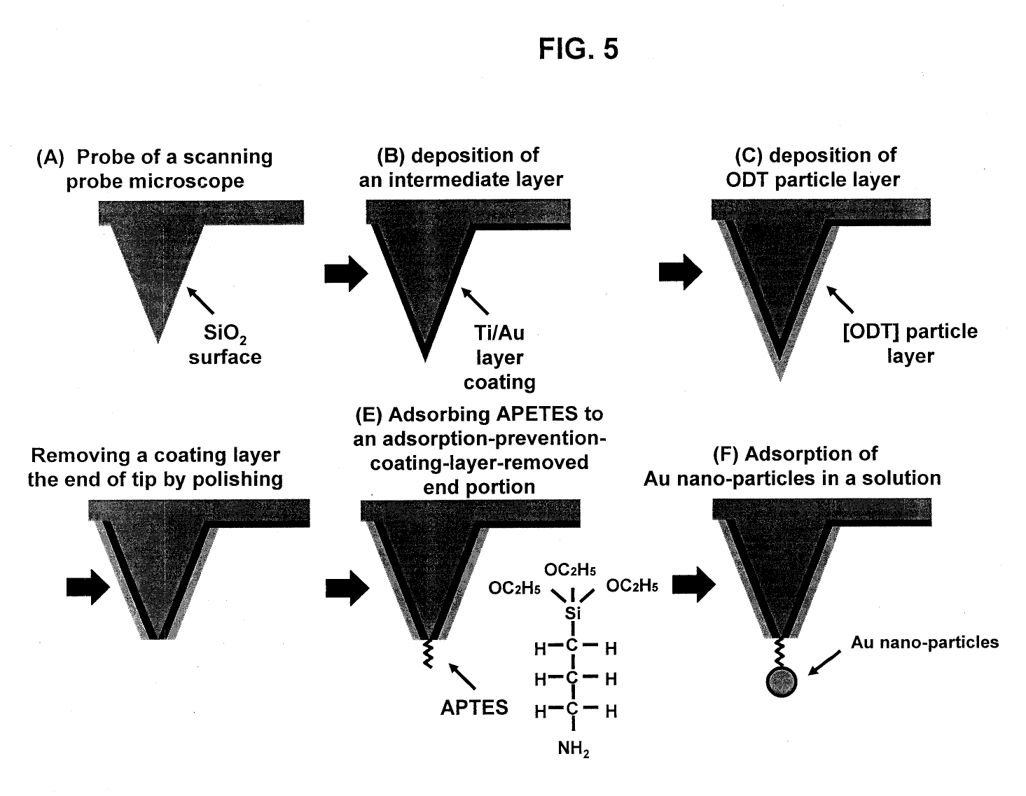

In this case, the nano-structure can be adsorbed on the end portion of the probe through the medium of the linker molecule. That is, after one end of the predetermined linker molecule easily adsorbing the predetermined nano-structure is adsorbed on the end of the probe ((E) of FIG. 4), the probe is immersed into the solution or the gas containing the adsorbed linker molecule and into the solution or the gas containing the nano-particle to perform the selective adsorption. Thereafter, the nano-structures are selectively adsorbed on the other end of the linker molecule (referring to (F) of FIG. 4 and FIG. 5).

As the specific embodiment of the present invention, the process of adsorbing an Au nano-particle on the end portion of the probe having a SiO₂ surface is described with reference to FIG. 5.

If the probe surface is made of SiO₂ and in case when the octadecanethiol (ODT) molecular layer is used as an adsorption prevention coating layer, since the direct adsorption is difficult, the ODT molecular layer is adsorbed on the probe surface through the following processes.

After the Ti layer serving as an adhesive is deposited on the SiO₂ surface ((A) of FIG. 5) of the probe, the Au layer is deposited on the deposited the Ti layer using thermal evaporation method ((B) of FIG. 5). The thickness of the deposited the Ti/Au layer as an intermediate layer is ranging from 10 nm-30 nm.

The ODT molecular layer with very low adsorption is deposited on the Au surface in the intermediate layer of the Ti/Au layer as the adsorption prevention coating layer ((C) of FIG. 5). More specifically, by immersing the probe into the solution obtained by solving 1-ODT in acetonitrile for approximately 30 seconds, the ODT molecular layer is formed on the Au layer. In this case, the concentration of ODT/acetonitrile is approximately 3 mM.

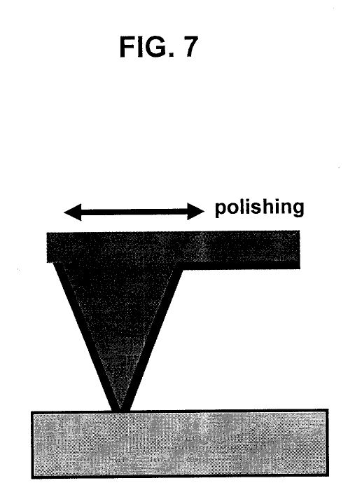

After the probe is installed on a scanning probe microscope such as the atomic force microscope (AFM), Si of the probe is exposed by removing the Ti/Au layer and the ODT molecular layer formed on the end portion of the probe, wherein removing of the Ti/Au layer and the ODT molecular layer is implemented by scanning, i.e., polishing (referring to FIG. 7) the predetermined region, e.g., 20 μm×20 μm region, on the hard surface such as silicon (Si) wafer approximately 3 times with approximately 4 nN force.

On the other hand, the solution is prepared by solving aminopropyltriethoxysilane (APTES) in ethanol. In this case, the concentration of APTES/ethanol is approximately 2% (vol/vol). And if the probe, from which the layer of the end portion is removed, is immersed into this solution for approximately 10 minutes, one end of the APTES is deposited at the probe end (see (E) of FIG. 5).

If the probe is immersed into the Au colloidal solution containing Au nano-particles having a diameter of approximately 50 nm for approximately one hour, Au nano-particles are selectively adsorbed on the other end of the APTES (see (F) of FIG. 5). Finally, Au nano-particles are selectively adsorbed on the end portion of the probe.

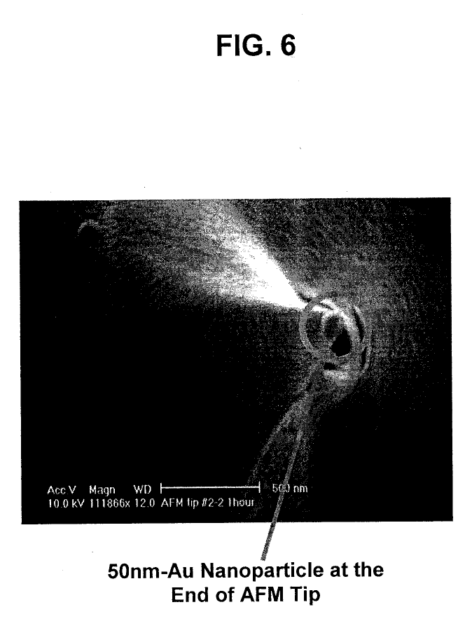

The nano-particle probe manufactured by this method is represented in FIG. 6. FIG. 6 is a scanning electron microscope (SEM) image photograph showing that 50 nm Au nano-particles are selectively adsorbed on the end portion of the probe.

Meanwhile, if the probe surface is made of SiO₂, an adsorption preventing 1-octadecryltrichlorosilane molecular layer can be directly deposited on the probe surface without utilizing the Au layer, if the probe surface is made of Au, the adsorption prevention ODT molecular layer can be directly deposited on the probe surface without utilizing the Au layer.

And also, in order to easily deposit the adsorption prevention coating layer, at least one layer may be formed between the probe and the coating layer.

Hereinafter, the present invention is described in more detail. In accordance with the embodiment of the present invention, nano-particles can be selectively adsorbed on the probe end of all type scanning probe microscope using the probe. For example, the probe of atomic force microscope (AFM), the probe of scanning tunneling microscope (STM), the probe of near field scanning optical microscope (NSOM) or the like can be employed as the probe microscope.

The adsorption prevention coating layer employed in the present invention can be generated by depositing an appropriate molecular layer according to the surface material of the used probe. More specific example is shown in the following table 1. In this case, the molecular layer can be deposited using the solution or the gas, this can be performed by using a previously developed conventional method.

As the different method for forming the adsorption prevention coating layer, shown in FIG. 4, after the appropriate intermediate layer, e.g., a solid thin layer, is firstly deposited on the probe surface, the adsorption prevention coating layer can be formed on the appropriate intermediate layer. For the intermediate layer, an evaporator, a sputter or the like can be used, and for the adsorption prevention coating layer, the deposition can be performed using the above described the solution or the gas.

TABLE 1

| Solid | Particle | |
|---|---|---|
| surface | shape | Specific example |
| Au | R—SH | C₁₂H₂₅SH, C₆H₅SH, n-hexadecanethiol, |
| | Ar—SH | n-octadecanethiol, n-docosanethiol, |
| | | C₁₀H₂₁SH, C₈H₁₇SH, C₆H₁₃SH |
| | RSSR′ | (C₂₂H₄₅)₂S₂ (C₁₉H₃₉)₂S₂, [CH₃(CH₂)₁₅S]₂ |
| | (disulfides) | |
| | RSR′ | [CH₃(CH₂)9]₂S |
| | (sulfides) | |
| | RSO₂H | C₆H₅—SO₂H |
| | R₃P | (C₆H₁₁)₃P |
| Ag | R—SH | C₁₂H₂₅SH, C₆H₅SH, n-hexadecanethiol, |
| | Ar—SH | n-octadecanethiol, n-docosanethiol, |
| | | C₁₀H₂₁SH, C₈H₁₇SH, C₆H₁₃SH |
| Cu | R—SH | C₁₂H₂₅SH, C₆H₅SH, n-hexadecanethiol, |
| | Ar—SH | n-octadecanethiol, n-docosanethiol, |
| | | C₁₀H₂₁SH, C₈H₁₇SH, C₆H₁₃SH |
| GaAs | R—SH | C₁₂H₂₅SH, C₆H₅SH, n-hexadecanethiol, |
| | Ar—SH | n-octadecanethiol, n-docosanethiol, |
| | | C₁₀H₂₁SH, C₈H₁₇SH, C₆H₁₃SH |
| InP | R—SH | C₁₂H₂₅SH, C₆H₅SH, n-hexadecanethiol, |
| | Ar—SH | n-octadecanethiol, n-docosanethiol, |
| | | C₁₀H₂₁SH, C₈H₁₇SH, C₆H₁₃SH |
| Pt | RNC | (C₅H₆)Fe(C₅H₅)—(CH₂)₁₂—NC |
| SiO₂, glass | RSiCl₃ | C₁₀H₂₁SiCl₃, C₁₂H₂₅SiCl₃, C₁₆H₃₃SiCl₃, |
| | RSi(OR′) | C₁₂H₂₅SiCl₃, CH₂═CHCH₂SiCl₃, |
| | | octadecyltrichlorosilan |
| Si | (RCOO)₂ | [CH₃(CH₂)₁₀COO]₂, [CH₃(CH₂)₁₆COO]₂ |
| Si—H | (neat) | |
| | RCH═CH₂ | CH₃(CH₂)₁₅CH═CH₂, CH₃(CH₂)₈CH═CH₂ |
| | RLi, RMgX | C₄H₉Li, C₁₈H₃₇Li, C₄H₉MgX, |
| | | C₁₂H₂₅MgX, X═Br or Cl |
| Metal | RSiCl₃ | C₁₀H₂₁SiCl₃, C₁₂H₂₅SiCl₃, C₁₆H₃₃SiCl₃, |
| oxides | RSi(OR′)₃ | C₁₂H₂₅SiCl₃, CH₂═CHCH₂SiCl₃, |
| | | octadecyltrichlorosilane |
| | RCOO— . . . MOn | C₁₅H₃₁COOH, H₂C═CH(CH₂)₁₉COOH |
| | RCONHOH | |
| ZrO₂ | RPO₃H₂ | |
| In₂O₃/SnO₂ | RPO₃H₂ | |
| (ITO) | | |
| Various | RSiCl₃ | C₁₀H₂₁SiCl₃, C₁₂H₂₅SiCl₃, C₁₆H₃₃SiCl₃, |
| Oxide | RSi(OR′)₃ | C₁₂H₂₅SiCl₃, CH₂═CHCH₂SiCl₃, |
| surfaces | | Octadecyltrichlorosilane |

In the present invention, the removal of the layer formed on the end portion of the probe can be performed by polishing the end portion of the probe. The polishing method can employ conventionally developed methods, and one example is that the probe is directly in contact with the object surface or the polishing method can use a focused ion beam (FIB). For the direct contact method, one or a plurality of probes on the wafer is in contact with the solid surface, and the solid surface is scratched several times. In FIG. 7, the method for removing the adsorption prevention coating layer formed on the end portion of the probe by such polishing is shown.

More specifically, after one or a plurality of probes is in contact with a hard solid surface such as SiO₂ by installing one or a plurality of probes on an atomic force microscope (AFM), there is the method for scanning a predetermined region using a force ranging from 2 to 100 nN for one second to one day.

As mass production method, there is the method for removing the layer on the probe end portion of the wafer state using a chemical mechanical polishing (CMP) method.

And, in the present invention, the method for adsorbing the linker molecule is as follows. That is, the probe is immersed into a linker molecule solution or gas to adsorb the linker molecule on the end portion of the probe. More specifically, after the probe and APTES are immersed into the small and sealed container without contacting each other, the probe is kept in APTES steam for one second to 10 days by heating at temperature of approximately 60° C.

Thereafter, if the probe is maintained in the solution containing Au nano-particles or CdSe nano-particles for one second to 10 days, nano-particles are adsorbed on linker molecules attached to the probe end. In this case, appropriate linker molecules are previously well known according to the type and the material of the nano-structure to be adsorbed.

By using the present invention, it is possible that all types of nano-structures are selectively adsorbed on only probe end, and nano-structures include conductive nano-particles, fluorescent nano-particles, magnetic nano-particles, carbon nano-tubes, self-assembled monolayers (SAMs), deoxyribonucleic acids (DNAs), ribonucleic acids (RNAs), proteins, antigens, antibodies and cells or the like.

Particularly, conductive nano-particles are corresponding to Au, Ag, Ti, Cr, Pt, ZnO, a tin oxide, Pb, CeO₂, SiO₂ or the like. Fluorescent nano-particles are corresponding to CdSe, CdS, ZnS, GaAs, PbSe, InAs, CdTe and PbS. And, magnetic nano-particles are corresponding to Fe₃O₄, CoPt, Ni/NiO, FeAl, FePt, Co and CoO.

As the specific application example of the present invention, the probe adsorbing conductive nano-particles such as Au, Ag or the like can be applied to the nano-SERS imaging, the probe adsorbing fluorescent nano-particles such as CdSe can be applied to the nano-FRET, magnetic nano-particles such as Fe₃O₄ can be applied to the magnetic force microscope (MFM) and the probe adsorbing the protein particles can be applied to the measurement of the force between the proteins.

While the present invention has been described with respect to certain preferred embodiments, it will be apparent to those skilled in the art that various changes and modifications may be made without departing from the scope of the invention as defined in the following claims.

1. The method for selectively absorbing nano-structures on the end portion of the probe of a scanning probe microscope, the method comprising the steps of:
forming the adsorbing prevention coating layer on the probe surface of a scanning probe microscope;
removing the adsorbing prevention coating layer formed on the end portion of the probe; and
adsorbing nano-structures on the end portion of the probe from which the adsorbing prevention coating layer is removed, in the solution or the gas containing nano-structures.

2. The method as recited in claim 1, after the step of removing the adsorbing prevention coating layer, further comprising the steps of:
adsorbing one end of the linker molecule on the end portion of the probe from which the adsorbing prevention coating layer is removed; and
adsorbing the nano-structure on the other end of linker molecule in the solution or the gas containing the nano-structure.

3. The method as recited in claim 1, wherein the step of forming the adsorbing prevention coating layer is characterized in that, after performing the step of forming at least one intermediate layer on the probe surface, the adsorbing prevention coating layer is formed on the intermediate layer; and the step of removing the adsorbing prevention layer is characterized in that at least the portion of the intermediate layer and the adsorbing prevention coating layer formed on the end portion of the probe is removed.

4. The method as recited in claim 3, wherein removing of the intermediate layer and the adsorbing prevention coating layer is performed by polishing.

5. The method as recited in claim 4, wherein nano-structures selectively adsorbed on the probe end or the other end of the linker molecule is made of the material selected from the group consisting of conductive nano-particles, fluorescent nano-particles, magnetic nano-particles, carbon nano-tubes, self-assembled monolayers (SAMs), deoxyribonucleic acids (DNA), ribonucleic acids (RNAs), proteins, antigens, antibodies and cells or the like.

6. The method as recited in claim 5, wherein the conductive nano-particle is the material selected from a group consisting of Au, Ag, Ti, Cr, Pt, ZnO, a tin oxide, Pb, CeO₂, SiO₂ or the like.

7. The method as recited in claim 5, wherein the fluorescent nano-particle is the material selected from a group consisting of CdSe, CdS, ZnS, GaAs, PbSe, InAs, CdTe and PbS.

8. The method as recited in claim 5, wherein the magnetic nano-particle is the material selected from a group consisting of Fe₃O₄, CoPt, Ni/NiO, FeAl, FePt, Co and CoO.

9. The method as recited in claim 5, further comprising:
the intermediate layer formation step of forming the Ti layer and the Au layer on the probe surface sequentially as the intermediate layer, wherein the thickness of the intermediate layer is ranging from 10 nm to 30 nm;
the adsorption prevention coating layer formation step of forming octandecanethiol (ODT) molecular layer on the Au layer by depositing the probe for approximately 30 seconds in the solution obtained by solving 1-ODT into acetonitrile;
the adsorption prevention coating layer removing step of scanning a silicon wafer surface by 4 nN force using the probe;
the linker molecule adsorption step of adsorbing one end of aminopropyltriethoxysilane (APTES) to the probe end by immersing the probe into the solution obtained by solving APTES in ethanol for approximately 10 minutes; and
the nano-structure adsorption step of adsorbing an Au nano-particle with 50 nm diameter to the other end of APTES by immersing the probe into the Au colloidal solution for approximately 1 hour.

10. The Scanning probe microscope installed thereon a probe, scanning probe microscopes comprising:
the adsorption prevention coating layer formed on a probe surface except the end portion of the probe; and
the probe provided with a nano-structure selectively adsorbing to the end portion of the probe.

11. The Scanning probe microscope as recited in claim 10, further comprising:
the linker molecule provided with one terminal group adsorbed to the probe end portion and the other terminal group adsorbing to the nano-structure.

12. The Scanning probe microscope as recited in claim 10, wherein at least one intermediate layer is formed between the probe surface and the adsorption prevention coating layer.

13. The Scanning probe microscope as recited in claim 10, wherein the nano-structure selectively adsorbed on the probe end portion or terminal groups of the linker molecule is made of the material selected from a group consisting of conductive nano-particles, fluorescent nano-particles, magnetic nano-particles, carbon nano-tubes, self-assembled monolayers (SAMs), deoxyribonucleic acids (DNAs), ribonucleic acids (RNAs), proteins, antigens, antibodies and cells or the like.

14. The Scanning probe microscope as recited in claim 13, wherein the conductive nano-particle is the material selected from the group consisting of Au, Ag, Ti, Cr, Pt, ZnO, a tin oxide, Pb, CeO₂, SiO₂ or the like.

15. The Scanning probe microscope as recited in claim 13, wherein the fluorescent nano-particle is the material selected from the group consisting of CdSe, CdS, ZnS, GaAs, PbSe, InAs, CdTe and PbS.

16. The Scanning probe microscope as recited in claim 13, wherein the magnetic nano-particle is the material selected from the group consisting of Fe₃O₄, CoPt, Ni/NiO, FeAl, FePt, Co and CoO.
